(19) United States
(12) Patent Application Publication
(10) Pub. No.: US 2006/0015405 A1
(43) Pub. Date: Jan. 19, 2006

(54) SOFTWARE AGENT FOR FACILITATING ELECTRONIC COMMERCE TRANSACTIONS THROUGH DISPLAY OF TARGETED PROMOTIONS OR COUPONS

(75) Inventors: Ravi N Bala, Blue Bell, PA (US); Dana B Hoffer, Wallingford, PA (US); Todd H Radel, Phoenixville, PA (US); Christopher G Connolly, Harleysville, PA (US)

Correspondence Address: SNELL & WILMER;ONE ARIZONA CENTER, 400 EAST VAN BUREN, PHOENIX, AZ, 850040001, US

(73) Assignee: KNOWLEDGEFLOW, INC., Valley Forge, PA (US)

(21) Appl. No.: 11/163,028

(22) Filed: Oct. 3, 2005

Related U.S. Application Data
(63) Continuation of application No. 09/949,890, filed on Sep. 12, 2001.
(60) Provisional application No. 60/230,931, filed on Sep. 13, 2000.

(51) Int. Cl. G06Q 30/00

(52) U.S. Cl. 705/14

(57) ABSTRACT

A software agent for locally tracking a user's network interaction, such as web browsing, and providing targeted promotions with optional coupons to the user. The monitoring involves use of a downloaded file of network addresses and words potentially tailored to each individual user. The software agent locally compares network addresses and content of web sites accessed and search terms entered against the stored addresses and key words in the file. Upon detecting a match, the software agent contacts a system server to obtain a promotion with an optional coupon for the match, and displays an indication of the promotion or coupon to the user, providing the user with the option to view, decline, save, or defer the promotion. The user is provided with redeemable credits for viewing promotions, visiting the site of a merchant offering the promotion, completing a transaction, and spending at least a threshold dollar amount. The coupons can include coupons targeted to users geographically close to particular merchants so that the coupons can be printed and redeemed at the merchant's establishment. Transactions related to the promotions, whether completed online or in-store, are confirmed to demonstrate the efficacy of the promotions, award additional loyalty rewards to a user's account, or to compensate an advertiser or affiliate. Confirmation of in-store transactions may be accomplished by accessing transaction data routed through third-party payment networks used for credit and debit card transactions and cellular phone transactions and the like.

### CROSS-REFERENCE TO RELATED APPLICATIONS

The present application is related to U.S. provisional application Ser. No. 60/230,931, filed Sep. 13, 2000 and U.S. non-provisional application Ser. No. 09/949,890, filed Sep. 12, 2001, which are incorporated by reference as if fully set forth herein.

### FIELD OF INVENTION

The present invention relates to an apparatus and method for facilitating electronic commerce transactions for a user by monitoring the user's network interaction for display of targeted on-line promotions and coupons.

### BACKGROUND OF INVENTION

Web browsers are typically used to access web sites via the Internet in order to execute electronic commerce transactions. Users can launch the web browsers from computers having a connection with the Internet in order to search for particular web sites and execute electronic commerce transactions such as shopping for products on-line. The users, however, typically must search themselves for particular web sites that meet their desired shopping interests and do not necessarily have an incentive for visiting any particular web site. Accordingly, a need exists for a software agent to facilitate electronic commerce transactions for users.

### SUMMARY OF INVENTION

A method and apparatus consistent with the present invention provide on-line promotions to users. A user's network interaction is locally monitored by, for example, detecting network addresses of sites accessed and comparing that information to a local file of key terms and addresses, potentially related to the user. If a match is found, the method and apparatus can contact a system server, or other entity, to obtain a promotion for the match and present it to the user. The method and apparatus can also search for promotions based upon a saved user-entered search query or “wish list” items, and continue to search and send notifications of promotions even when the user is off-line. Users may elect to view promotions, defer viewing promotions, save promotions for future viewing, or decline future related promotions. The method and apparatus facilitate confirmation of in-store as well as online transactions related to offered promotions through authorized access to payment network transaction data. Users may receive redeemable credits for viewing a promotion, saving a promotion for later viewing, viewing additional information, visiting a vendor, consummating a transaction, or spending beyond a certain dollar threshold value. Consumer review and chat features may also be offered in connection with presented promotions.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram conceptually illustrating operation of a software agent for displaying targeted promotions or coupons;

FIG. 2 is a diagram of a system for presenting on-line promotions and coupons to users and performing related processing;

FIGS. 3 and 4 are a flow chart of a method for presenting on-line promotions to users;

FIG. 5 is a flow chart of a method for searching for promotions;

FIG. 6 is a flow chart of a method for providing user access to an on-line account;

FIG. 7 is a diagram of a screen for providing an indication of a promotion;

FIG. 8 is a diagram of an introductory screen for a promotion;

FIG. 9 is a diagram of an information screen for a promotion;

FIG. 10 is a diagram of a screen for receiving a search query;

FIG. 11 is a diagram of a screen for presenting search results; and

FIG. 12 is a diagram of a screen for providing user account information.

### DETAILED DESCRIPTION

A software agent for implementing the present invention resides locally on a user's machine in order to track the user's network interaction and provide targeted promotions with optional coupons to the user. Promotions include any type of offer for which a user can receive credits or other incentives, for example by viewing, saving, accepting, redeeming or otherwise acting upon or interacting with the offer. Upon detecting a user logging onto the network, such as via launching a web browser, the software agent contacts a system server and downloads a file for use in monitoring the user's network interaction. The file can contain any information for the monitoring including, for example, key words and network addresses such Uniform Resource Locaters (URLs). The system server can individually generate the file for each user depending upon, for example, the profile for the user and promotions or coupons offered by merchants. In this manner, promotions or coupons potentially relevant to the user's interests can be retrieved for that user, and coupons or promotions for merchants geographically close to the user can be retrieved as well.

As the user interacts with the network, the software agent monitors the interaction via a browser, for example. Network interaction can include, for example, browsing various web sites on the World Wide Web, entering words or terms for searches, accessing network sites, or other network navigation. During the user's network interaction, the software agent monitors and detects addresses of sites accessed and potentially words entered such as when performing a search. The software agent compares the addresses and words with the stored addresses and key words in the file to determine if a match exists. In one embodiment, the software agent scans and compares the contents of an accessed web page against stored terms associated with various promotions. This capability may be restricted to one specific page, such a home page, or may include a group of html pages for each specific offer or promotion. For example, all web pages having a certain second or third level domain in common may be designated for scanning by the software agent.

When the software agent finds a match, it contacts the system server to obtain the promotion for the match and displays to the user an indication that a related promotion is available for viewing. It can also obtain a coupon and display that as well. The user can be provided with options to view the promotion, decline display of the promotion, defer display of a promotion, save the promotion, accept a promotion, or the like. The user may receive redeemable credits for selection of different options. The promotion can also be associated or linked with a web site of the merchant offering the promotion. When the user views the promotion, the software agent can transfer the user's network connection via the browser to that merchant site.

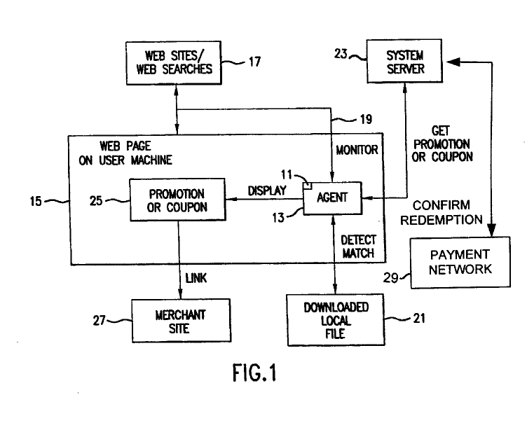

FIG. 1 is a diagram conceptually illustrating this operation of the software agent for displaying targeted promotions or coupons. The software agent 13 monitors 19 web sites accessed and searches performed 17 by a user via a web page 15 using a browser. Upon detecting a match using a downloaded local file 21, the software agent 13 obtains a corresponding promotion or coupon from a system server 23 and displays an icon 11 for it, or otherwise provides an indication of it, to signal the user of the availability of the promotion or coupon. When a user selects the icon 11, the software agent 13 displays the promotion or coupon 25, or both. The promotion or coupon 25 can have a link to a merchant site 27 sponsoring it in order to display a home page, for example, of the merchant site to the user in web page 15. Although shown within an environment using browsers to displays web pages from the Internet, the software agent can be used within any type of networked environment.

System server 23 may then monitor an online redemption of a promotion or confirm an offline or in-store redemption of a promotion by accessing a payment network 29. System server 23 obtains transaction data routed through or stored on payment network 29 to determine if a user has made a purchase related to a promotion earlier presented to that user. Such confirmation may be completed in real-time in the case of a purchase at a vendor website. Alternatively, such confirmation may be asynchronous, with the promotion, redemption, and confirmation being logged over a period of time. Payment network 29 includes credit card and debit card issuer networks, loyalty program networks, cellular communication networks, and the like.

To help illustrate operation of the software agent, the following provides two examples of how it may work. As an example, a user accesses a search engine, such as the Yahoo! home page, and enters the query “jacuzzi.” Upon receiving the search results relating to “jacuzzi,” the software agent flashes an icon displayed to the user or otherwise indicates the availability of a promotion (offer). The user “clicks on” the flashing icon and is presented with a pop-up window with an offer from a Home Depot retailer for a special on jacuzzis. The user “clicks on” the offer and is transferred from the Yahoo! search engine page to the Home Depot page featuring its promotional jacuzzi. As another example, a user is viewing the MSN home page and “clicks on” news concerning best buys for automobiles. While the MSN system transfers the user to the Carpoint on-line environment, the software agent flashes an icon displayed to the user or otherwise indicates the availability of a promotion (offer). The user “clicks on” the flashing icon and receives a pop-up window with an offer from a local car dealer located geographically close to the user. In both of these examples, the user receives credits for viewing the offer. These two examples are provided for illustrative purposes only and many other types of promotions and implementations are possible.

In a third example, a user logs in to the web site of an airline using a frequent flyer number or similar identification. Various user profile criteria associated with the user's frequent flyer account are then used to populate promotions for presentation to the user. Exemplary profile criteria include the membership status (e.g., gold, silver, or preferred), age, gender, zip code, customer relations classification (e.g., new customer, developing, established, highly valued, or waning), and the like. Similarly, promotions may be populated or updated based on any number of user interactions with site content or searches performed within the airline website or other websites. The user may receive additional frequent flyer points for viewing or for redeeming a given promotion. For example, a highly valued gold member or a new customer may be awarded a greater number of frequent flyer points than a waning customer for opting to redeem a promotion to eat for the first time at a given restaurant. Transaction data obtained from third-party payment networks serves to confirm when a given frequent flyer customer has opted to complete a purchase or otherwise act based on a previously viewed promotion. Thus, frequent flyer points may be automatically added to the customer's account based on the purchase. Promotions and associated redemption values may be selected and adjusted based on any combination of user profile criteria, user activity, or user search terms.

Locally monitoring the user's network interaction in this manner can provide several advantages. For example, providing the user with the option to decline the promotion helps promote permission-based marketing, which tends to be less disruptive to a user's on-line experience than automatically displaying promotions to the user. Locally monitoring the user's network interaction enhances user privacy by not tracking the user's browsing habits on a remote server. This feature can also enhance the speed of network interaction in that the software agent need only contact the server when it finds a match and thus need not be in constant communication with the server.

By generating a file for each user, promotions and coupons can be targeted to each individual user. Furthermore, local merchants can target promotions and coupons to users located geographically close to them. In addition to potentially enhancing on-line shopping, the software agent can potentially enhance in-store shopping and purchases as well by providing coupons for in-store redemption, providing cost-effective means for smaller, local merchants to target consumers and compete with large, national merchants.

Both on-line and off-line, i.e., in-store, redemptions of offered promotions are tracked to confirm the efficacy of offered promotions. In one embodiment, tracking is accomplished using unique identifiers for each viewed promotion. The unique identifier may be in the form of a bar code or numeric code to be entered by the merchant in an in-store transaction or may be entered in a promotion field upon checkout in an on-line purchase. The unique identifiers may then be used by the on-line and in-store merchants in reconciling accounts with the source of the promotion, for example when a hardware store honors a particular vendor promotion. Redemption of a uniquely identified promotion presented to a consumer online may thus serve to provide feedback and performance tracking for various promotions based on both online and in-store transactions.

In another embodiment, on-line and/or in-store transactions are associated with a promotion for tracking by recording on system server 23 an indication of promotions viewed by a user and accessing or monitoring the user's transaction data on payment network 29 to identify transactions related to viewed promotions. For example, a user may view promotion 25 for reduced admission charges at the local zoo. System server 23 or software agent 13 then periodically accesses a payment network transaction log through an authorized gateway to determine if the user paid admission charges to the zoo using payment network 29. In other words, a user's profile may indicate that she frequently uses two particular credit cards. The system accesses transaction data routed through corresponding payment networks 29 to determine if the user has availed herself of an offered promotion 25 using either of the cards. In an alternative embodiment, payment network data may include data relating to transactions made using a cellular phone. For example, cellular phone numbers may be used as an account number to pay for a purchase, with the transaction being recorded for payment as part of the user's phone bill.

Transaction data related to any number of credit cards, debit cards, charge cards, gift cards, speed passes, loyalty points accounts, cell phone accounts, and the like may be used to confirm the occurrence of an on-line or in-store transaction related to an offered promotion. Thus, the method and apparatus provide feedback and performance mechanisms related to targeting offerings of promotions online, whether redemption of the promotion occurs on-line or off-line in a store. Similar mechanisms may be used to track and confirm transactions involving redemption of loyalty points awarded by the system

In yet another embodiment, transaction data obtained from various payment networks 29 may be used to inform a user profile. For example, a confirmed transaction related to a promotion may be recorded in a user's profile and used in determining whether to offer future related promotions to that user. Alternatively, payment network transaction data may be used to initially populate certain fields in a user profile. For example, identification of threshold dollar amounts spent at various stores may be used to identify user interests and categories of promotions to be offered to the user.

This implementation of a software agent also provides certain information to a remote system server that can be used to generate statistical information. For example, the system server can record an indication of each promotion provided and how many times each is provided. User privacy may be maintained by not associating individual users with each promotion. The system server may be used to compile aggregate (volume) non-personal data for merchants to help them evaluate and tailor the effectiveness of each promotion or coupon. For example, promotions having a low viewing rate can be discontinued or associated with a broader base of network addresses and key words.

Providing redeemable credits to users for viewing promotions can help promote loyalty-based marketing. Users have an incentive to view promotions by receiving redeemable credits for the viewing, and they can accumulate credits as they continue to view promotions. The credits can be redeemed in many ways, such as through conversion of the credits to airline miles in frequent flier programs, specific merchandise, or discounts with retailers or merchants. Users may receive redeemable credits, such as loyalty program points, for viewing a promotion, saving a promotion for later viewing, viewing additional information, visiting a vendor online, consummating a transaction, or spending beyond a certain dollar threshold value. Redeemable points may be used, for example, as partial or complete payment for an item on a sponsor web site.

The software agent can be used for revenue generation. In particular, users can optionally be charged subscription fees for use of the software agent to receive promotions, coupons, and redeemable credits for viewing them. Merchants can optionally be charged a fee for each of their promotions or offers delivered, or charged a fee for each transaction resulting from display of their promotions or coupons. The system server can track this information for charging merchants, in the same manner that it can accumulate aggregate information concerning promotions and coupons as identified above.

As another option, the software agent can operate and be implemented as a stand-alone program or, alternatively, can communicate and be integrated with other loyalty programs.

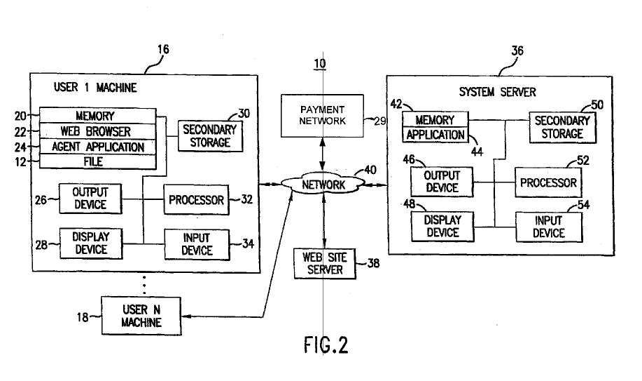

FIG. 2 is a diagram of a system 10 for presenting on-line promotions to users and performing related processing. System 10 includes user machines 16 and 18 connected to a network 40 such as the Internet or other type of network. Users at user machines 16 and 18 can access various web sites to obtain content from the World Wide Web, represented by web site server 38. A system server 36 is connected with network 40 and can be accessed by user machines 16 and 18 to download information for locally determining whether to present a promotion or coupon, and for obtaining promotions from system server 36. A payment network 29 is accessible over network 40 by user machines 16 and 18 and website server 38 for conducting transactions. Payment network 29 is further accessible over network 40 by system server 36 for monitoring and confirming the redemption of offered promotions. Only two user machines are shown for illustrative purposes only; system 10 may include many user machines and may be scalable to add or delete user machines to or from the network.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality.

The various system components may be independently, separately or collectively suitably coupled to network 40 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods. It is noted that network 40 or payment network 29 may be implemented as other types of networks, such as a cellular telephone network or an interactive television (ITV) network. Moreover, the system contemplates the use, access, viewing, copying, sale or distribution of any information, goods or services over any network 40 having similar functionality described herein.

User machine 16 illustrates typical components of a user machine. User machine 16 may be a personal computer, cell phone, personal mini-computer, network computer, workstation, mainframe, and the like. User machine 16 typically includes a memory 20, a secondary storage device 30, a processor 32, an input device 34, a display device 28, and an output device 26. Memory 20 may include random access memory (RAM) or similar types of memory and it may store one or more applications, such as agent application 24 as described below, and a web browser 22, for execution by processor 32. Memory 20 may also store a downloaded file 12 for use in determining whether to retrieve and present a promotion to the user, as described below.

Secondary storage device 30 may include a hard disk drive, floppy disk drive, CD-ROM drive, or other types of non-volatile data storage. Processor 32 may execute applications or programs stored in memory 20 or secondary storage 30, or received from the Internet or other network 40. Input device 34 may include any device for entering information into machine 16, such as a microphone, digital camera, video recorder or camcorder, keyboard, cursor-control device, or touch-screen. Display device 28 may include any type of device for presenting visual information such as, for example, a computer monitor or flat-screen display. Output device 26 may include any type of device for presenting a hard copy of information, such as a printer, and other types of output devices include speakers or any device for providing information in audio form.

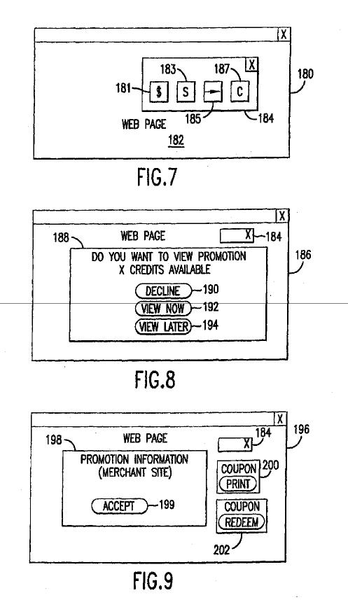

Web browser 22, in conjunction with agent application 24, is used to access information via network 40 and display it in web pages, and examples of those pages are shown in the screens provided in FIGS. 7-12. Examples of web browsers include the Firefox, AOL, and Microsoft Internet Explorer programs. Any web browser or other application capable of retrieving content from a network and displaying pages or screens may be used. User machine 18 may include the same components as user machine 16. Therefore, examples of user machines for displaying promotions and coupons include personal computers, laptop computers, notebook computers, palm top computers, network computers, or any processor-controlled device capable of executing a web browser or other type of application for interacting with the system.

System server 36 typically includes a memory 42, a secondary storage device 50, a processor 52, an input device 54, a display device 48, and an output device 46. Memory 42 may include random access memory (RAM) or similar types of memory and it may store one or more applications 44 for execution by processor 32. Secondary storage device 50 may include a hard disk drive, floppy disk drive, CD-ROM drive, or other types of non-volatile data storage. Processor 52 may execute one or more applications or programs stored in memory 42 or secondary storage 50, or received from the Internet or other network 40. Input device 54 may include any device for entering information into server 36, such as a microphone, digital camera, video recorder or camcorder, keyboard, cursor-control device, or touch-screen. Display device 48 may include any type of device for presenting visual information such as, for example, a computer monitor or flat-screen display. Output device 46 may include any type of device for presenting a hard copy of information, such as a printer, and other types of output devices include speakers or any device for providing information in audio form.

Server 36 stores a database structure in secondary storage 50, for example, for storing and maintaining information for users such as user profiles and files to be downloaded by the local agent application for use in monitoring the users' network interaction. Processor 52 may execute one or more applications 44 in order to provide information to agent application 24 and to provide the web pages shown in the screens of FIGS. 7-12. Although only one server is shown, system 10 may use multiple servers as necessary or desired to support the users and may also use back-up or redundant servers to prevent network downtime in the event of a failure of a particular server.

Although machine 16 and server 36 are depicted with various components, one skilled in the art will appreciate that these machines and the server can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as machine 16 and server 36, to perform a particular method. As will be appreciated by one of ordinary skill in the art, the present invention may be embodied as a customization of an existing system, an add-on product, upgraded software, a stand alone system, a distributed system, a method, a data processing system, a device for data processing, and/or a computer program product.

FIGS. 7-12 are screens illustrating how users may interact with the system, and these screens may be displayed on display devices associated with the users'computers. The term “screen” refers to any visual element or combinations of visual elements for displaying information; examples include, but are not limited to, user interfaces on a display device or information displayed in web pages or in windows on a display device. The screens may be formatted, for example, as web pages in HyperText Markup Language (HTML), or in any other suitable form for presentation on a display device depending upon applications used by users to interact with the system.

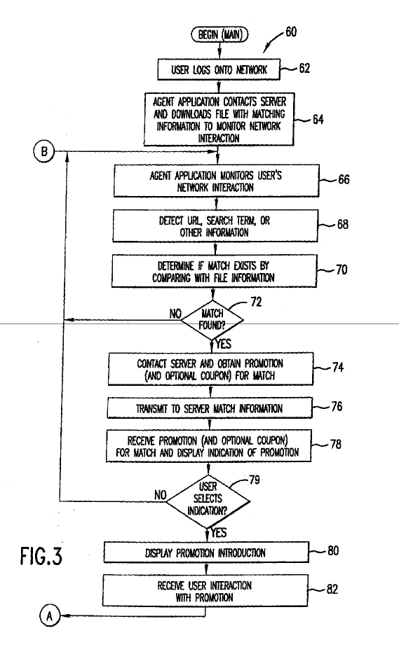

The screens include various sections, as explained below, to provide information or to receive information or commands. The term “section” with respect to screens refers to a particular portion of a screen, possibly including the entire screen. Sections are selected, for example, to enter information or commands or to retrieve information or access other screens. The selection may occur, for example, using a cursor-control device to “click on” or “double click on” the section; alternatively, sections may be selected by entering a series of key strokes or in other ways such as through voice commands or use of a touch screen. In addition, although the screens shown in FIGS. 7-12 illustrate a particular arrangement and number of sections in each screen, other arrangements are possible and different numbers of sections in the screens may be used to accomplish the same or similar functions of displaying information and receiving information or commands. Also, the same section may be used for performing a number of functions, such as both displaying information and receiving a command. The processing to support the screens in FIGS. 7-12 is shown in the flow charts of FIGS. 3-6. The processing may be implemented in software, such as software modules, for execution by computers or other machines.

FIGS. 3 and 4 are a flow chart of a method 60 for presenting targeted on-line promotions to users. Method 60 may be implemented in software modules, for example, for local processing on user machines such as via agent application 24. The agent application 24 interacts with web browser 22 and file 12 to monitor the user's network interaction, such as web sites accessed via the web browser 22, and to determine when to retrieve and display promotions and coupons. Initially, agent application 24 can be installed in a variety of ways for performing the processing of method 60. For example, it can be downloaded from a web site and thus offered, for example, on high traffic web sites. It can be distributed through an e-mail campaign sent to a sponsoring institution's customers. It can be distributed on portable media, such as a floppy disk or CD-ROM, and mailed, handed out, or otherwise provided to users. In addition, users can also be provided with the option to transmit coupons to others via an e-mail, for example, and provided with incentives for such distribution. For example, users may be provided with a coupon that increases in value according to the number of referral users who receive and/or redeem the coupon.

Upon the initial installation, agent application 24 may, for example, query the user in order to receive a user profile and transmit the user profile to server 36. The user profile can be used by server 36 to generate, for example, the file 12 containing the information, such as key words and network addresses, used by agent application 24 to determine when to retrieve and display a promotion. Any of the software, applications, or functionalities discussed herein may be entirely served based or may require installation on user machine 16, or a combination thereof.

The user profile can include an on-line form that the user completes and submits over the network, or a printed form to be mailed to an entity managing the promotions. The user profile form can include any information identifying or characterizing the user such as a name, address, gender, age, household income, and a set of check boxes indicating areas of interest such as hobbies and activities. A particular implementation can use more or fewer than these exemplary items, and users can potentially be categorized or grouped with other users based upon particular criteria involving the user profiles for targeting of promotions or coupons to that group. For example, users living in the same neighborhood can be categorized or grouped for receiving coupons for a local merchant in the neighborhood. User profiles and groupings may be automatically updated based upon the geographic location of user machine 16, for example, based upon location of a user's internet accessible cellular phone. As another example, users having a certain interest or hobby can be categorized or grouped to receive promotions relating to that interest. Therefore, the information in the user profile, or a sub-set of it, can be used to generate an individual file for each user for the local monitoring of the network interaction. Alternatively, the files can be generated for categories or groups of users based upon the user profile information or a sub-set of it. In addition, users may be queried to update their user profiles at any time or at a particular time.

In method 60, agent application 24 detects that the user logs onto the network via web browser 22 (step 62). Agent application 24 contacts server 36 and downloads file 12 containing the matching information for promotions (step 64). File 12 is typically stored in a local cache on the user's machine and can be implemented with, for example, an Extensible Markup Language (XML) file with key words and URLs. A new file for the user is preferably downloaded each time the user logs onto the network; alternatively, agent application 24 can use the same file for a particular period of time or network access. Table 1 provides an example of an XML file structure for specifying URLs and key words to locally monitor a user's network interaction. This file is provided only for illustrative purposes, and implementations can use other structures and programming languages.

TABLE 1
Exemplary Portion of XML File Structure
for URLs and Key Words

<?xml version=“1.0”?>
<rulebase fromServer=“WebAngel Demo Server”>
<rule>
<pattern type=“regex”>acmemarkets.com</pattern>
<promo_id>21</promo_id>
</rule>
<rule>
<pattern type=“regex”>shoprite.com</pattern>
<promo_id>21</promo_id>
</rule>
<rule>
<pattern type=“regex”>mortgage</pattern>
<promo_id>23</promo_id>
</rule>
<rule>
<pattern type=“regex”>diamonds.com</pattern>
<promo_id>28</promo_id>
</rule>
...etc.
</rulebase>

Agent application 24 then monitors the user's network interaction (step 66). For example, it detects via web browser 22 URLs of sites accessed by the user (step 68). It can also monitor and detect other types of information such as search terms entered by the user when performing Internet or network searches or the page content of accessed web pages (step 68). Any number of criteria may be selectively compared to determine the relevance of available promotions. Agent application 24 compares the detected information with information in file 12 to determine if a match exists (step 70). For example, it determines if the address of a web site accessed by the user matches a URL in file 12 or if a search term entered by the user matches a key word in file 12. If a match exists (step 72), agent application 24 contacts server 36 to obtain the promotion and optional coupon for the match (step 74). Agent application 24 transmits to server 36 the match information, such as the URL or key word matched in step 72 and can optionally send information identifying the user as well (step 76).

Server 36 may store the promotions and coupons linked or associated with URLs or key words in order to retrieve an appropriate promotion when contacted by agent application 24. It can optionally select targeted promotions by using user profile information to refine the selection. Server 36 can return the promotion to agent application 24 as an XML data stream, for example. An optional coupon may also be obtained (step 78), and the coupon can include on-line redeemable coupons to be redeemed via on-line purchases or in-store redeemable coupons to be printed and redeemed at a retailer or other entity. The server 36 may determine a type of in-store redeemable coupon to transmit to the user based upon geographic information so that a user can be provided with coupons redeemable at stores, for example, close to the user's residence. The server 36 can access the user's profile, for example, to obtain the user's address and use that information, such as a zip code, for retrieving an appropriate in-store redeemable coupon. Coupons may be redeemable on-line and/or in-store and may bear a tracking mechanism such as a unique numeric identifier to enable feedback or confirmation of coupon redemption. Alternatively, the coupons or promotions themselves may not be uniquely identifiable, with redemption tracking being performed by recording which users view a promotion and which users consummate a transaction related to the promotion, as determined by accessing payment network transaction logs to determine if certain users completed transactions with certain merchants or in connection to certain goods or services.

Agent application 24 then displays an indication of the promotion (step 80). FIG. 7 is a diagram of a screen 180 for providing an indication of a promotion. Screen 180 displays a web page 182 having content from a web site or other network site accessed by the user, which can include any content and depends upon sites accessed. A section 184 represents agent application 24 and can provide a visual indication of a promotion such as via display of an icon 181. Indications of available promotions can be provided in a variety of ways both visually and through audio information, or by a combination of the same. For example, the options for providing visual indications of promotions can include a screen, web page, icon, ticker display, symbol, or text message overlaid on web page 182 or otherwise provided. The options can also include a change in a visual appearance of displayed information such as, for example, by flashing icon 181 or changing its color. Alternatively, or in combination with the visual information, an audio message or alert can be provided such as, for example, a bell or chime.

By providing an indication of an available promotion, agent application 24 provides for permission-based marketing. The users are notified of promotions and decide whether to view the promotion, which tends to be less intrusive and disruptive to the user's on-line experience than automatically displaying promotions to the user. By using an icon 181, for example, the user is notified of promotions without significantly disrupting the user's network interaction. Section 184 can optionally include other features. For example, it can include an optional search icon 183 for selection by the user to execute a search function, as explained below. Selection of an optional “my links” icon 185 can provide the user with, for example, information other than a promotion or coupon, such as general product or service information from a merchant or a link to a web site. Selection of an optional chat icon 187 can link the user with an on-line chat room, potentially with other users viewing, for example, the same promotion or having the same interests. Alternatively, certain promotions may provide an active link to initiate a chat session with a vendor representative. Thus, vendors may be able to respond to user questions or concerns in real time, maintaining user interest and increasing the likelihood that the user will accept and act upon the promotion offered.

Similarly, consumer reviews may be offered in connection with a given promotion, providing the user with additional information or incentive to complete a transaction. For example, an icon may indicate a percentage of users who responded favorably to a promotion. Consumer reviews may be offered for the promotion itself, or in relation to the goods and/or services promoted. User's may be prompted to rate the promotion after viewing or particularly after accepting a promotion and completing a related transaction. The user's response may then inform consumer review data presented to subsequent users.

The appearance of the various icons 181, 183, 185, and 187 is provided for illustrative purposes only, and any appearance, shape, color, arrangement, and placement can be used. The software agent can use, for example, default settings for the icons or permit a user to change the appearance or configuration of them. As an alternative to icons, the software agent can be configured to allow the user to select these features in other ways such as through use of a keyed or voice input. Also, the user can optionally close section 184 in order to disable operation of software agent 24.

Returning to method 60, if the user selects the indication of the promotion (step 79), agent application 24 displays information concerning it. For example, a user may “click on” icon 181 to view the promotion information or enter other types of commands to view it. If selected, agent application 24 can optionally display a promotion introduction (step 80). FIG. 8 is a diagram of an introductory screen 186 for a promotion. In section 188, agent application 24 can provide information about the promotion including the number of credits associated with it, and agent application 24 can provide various options for the user to interact with the promotion. Alternatively, section 188 can be automatically displayed as part of the promotion indication and can be provided, for example, in a pull-down window beneath section 184. Agent application 24 can permit the user to decline the promotion (190), view the promotion (192), or save the promotion for viewing later (194). Agent application 24 can present users additional options to decline to view a promotion, defer viewing a promotion, view and save the promotion for later viewing, view additional promotions, omit similar future promotions, and the like. Saved or deferred promotions may be accessible through icon 181 or by any other suitable means.

Agent application 24 records a user's interaction with or response to the available promotion via selection of one of the sections 190, 192, or 194. If the user selects section 192 to view the promotion (step 84), agent application displays the promotion (step 92) and records an indication of it associated with the user's profile to locally track promotions viewed by the user (step 94). It also adds redeemable credits to the user's on-line account, for example, by transmitting to server 36 an indication of the points to be added (step 96). Varying credits may be assigned for any action or selection of any option related to an available promotion. For example, incremental increases in points may be awarded for electing to view a promotion, viewing additional information, visiting a vendor's web site, consummating a transaction, and spending at least a threshold dollar amount in connection with the promotion.

The agent application also determines whether, as part of the promotion, to transfer the user's network connection to a vendor's web site or to another network location (step 104). If the promotion includes that option, the agent application transfers the user's network connection to the respective site via web browser 22 (step 106). Vendors offering promotions may opt to allow users to use accrued redeemable points as partial or complete payment in connection with a promotion.

FIG. 9 is a diagram of an information screen 196 for a promotion to be displayed as part of step 92. Screen 196 includes a section 198 to display information for the promotion. Alternatively, section 198 can represent another site that the user's connection is transferred to as part of step 106. For example, the agent application 24 can transfer the user's network connection to a web site of a retailer or other entity offering the promotion. Screen 196 can also optionally display coupons including an on-line redeemable coupon 202 and an in-store redeemable coupon 200.

The promotion can also include the ability for the user to accept the promotion, as illustrated in section 199, for the purchase of goods or services, and the user can be awarded additional credits for acceptance of the offer. If the user accepts the offer (step 111), the software agent 24 can process the acceptance (step 113) and transmit an indication of additional credits, if any, to be added to the user's account (step 115). Processing the acceptance in step 113 can involve, for example, transferring the user's network connection to the merchant site or the system server to process the purchase. The user's profile may contain the user's address and credit card information, which the system server 36 can use to process the purchase or provide to another site for processing.

If the user selected section 190 to decline the promotion (step 86), agent application 24 removes the promotion introduction and the indication of the promotion (step 98). Agent application 24 can also delete this promotion for the user (step 108), meaning that it will not be provided to the user upon detecting the same match; alternatively, promotions can be saved for potentially displaying to the user again.

If the user selected section 194 to view the promotion later (step 88), agent application 24 records an indication of the promotion (step 100). It also removes the promotion introduction and the indication of the promotion (step 109). The user can optionally be provided with credits for selecting this option, in which case agent application 24 adds credits to the user's account (step 110). The processing for the user's interaction can also include other options (step 90) and associated processing (step 102).

Agent application 24 also determines whether to display a coupon (step 114), retrieved from server 36, such as coupons 200 or 202 as shown in screen 196. The determination can be based upon any criteria. For the in-store redeemable coupons, for example, agent application 24 can retrieve coupons for retailers located geographically close to the user's residence. For the on-line redeemable coupons, for example, agent application 24 can retrieve coupons associated with promotions displayed to the user. If a coupon is to be displayed to the user (step 118), agent application 24 can present an on-line coupon to the user (step 120). If the user wants to redeem it (step 122), as illustrated in coupon 202, agent application transmits the coupon or an indication of it to the on-line retailer and records an indication of the redemption (step 124).

Agent application 24 can also display in-store redeemable coupons to the user (step 126) and provide the user with the option to print it (step 128), as illustrated in coupon 200. If the user selects the print option (step 130), agent application 24 transmits the coupon to a local printer for the user's machine (step 131). Agent application 24 also records an indication of the coupons presented in order to locally track which coupons have been presented to the user to measure promotion performance relative to in-store transactions related to the offered promotion. Agent application 24 continues to monitor the user's network interaction (step 132) while the user is on-line, and it returns to step 66 to repeat the process.

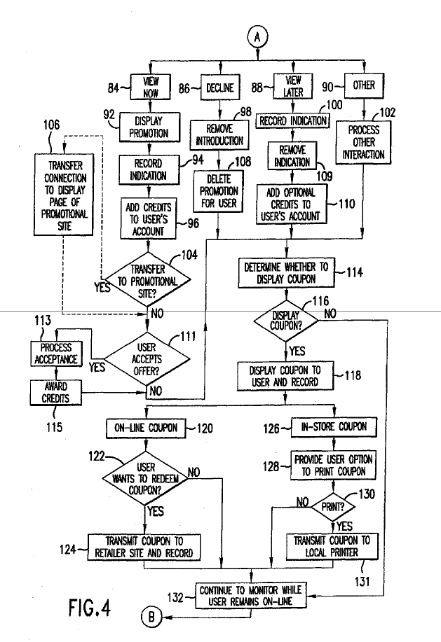

FIG. 5 is a flow chart of a method 140 for searching for promotions. Method 140 can be implemented, for example, in software modules as part of agent application 24 for its processing as described below. In method 140, agent application 24 receives a user's request to search for promotions (step 142). For example, section 184 for providing an indication of promotions may also include the icon 183 for selection by the user to search for promotions. Alternatively, the user can access the search function in other ways such as through a pull-down menu or entered command.

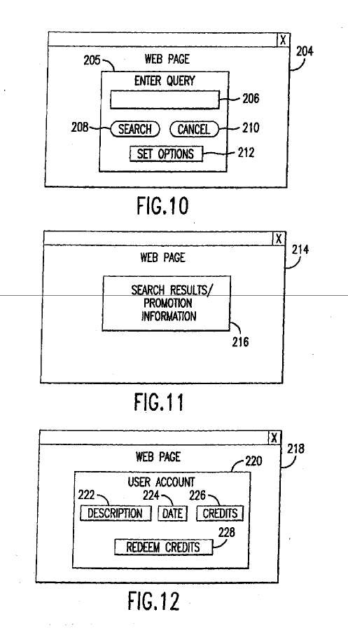

Agent application 24 displays a search section for the user to enter a query (step 144). FIG. 10 is a diagram of a screen 204 for receiving a search query. Screen 204 includes a section 205 for the search. A user can enter a query in section 206 and select a section 208 to search for a promotion satisfying the query or select a section 210 to cancel the search. The search function alternatively can provide the user with options to set for searching, as represented by a section 212. For example, the user can specify only particular types of promotions or only promotions for retailers geographically close to the user.

Agent application 24 receives the user's search query (step 146) upon the user's selection of section 208, and it performs a search (step 148) to determine if a match exists (step 150). To perform the search, agent application 24 can transmit to server 36 the search query and possibly options for searching. Server 36 can then search its database, and possibly other databases, of stored promotions to determine if a promotion exists that satisfies the search query and options. If a match exists (step 150), agent application 24 displays an indication of the match and the promotion (step 152). FIG. 11 is a diagram of a screen 214 for presenting search results. A section 216 can provide one or more promotions satisfying the search, and the promotion can include the options for interaction with it as described above.

The search function can optionally continue to search for promotions even when the user is no longer on-line. For example, agent application 24 can set a time parameter (step 154) with the system server. When the time has expired, or the time parameter is otherwise satisfied (step 156), server 36 performs the search again and, if a match exists (step 158), it notifies the user (step 160). Server 36 can send an e-mail to the user, for example, to notify the user of the promotion. Alternatively, the user can be notified in other ways such as via a page, or a cell phone or telephone call with a recorded message. If the server is to continue searching (step 162), it waits until the time parameter is satisfied again to perform another search. Other options exist for determining whether the searching should continue; for example, the server may continue the searches for a maximum time period or maximum number of searches, or discontinue the searches based upon a user-specified parameter. The continued searching can alternatively be performed by agent application 24 repeatedly contacting the server; however, for that option the user's machine must have continual on-line access.

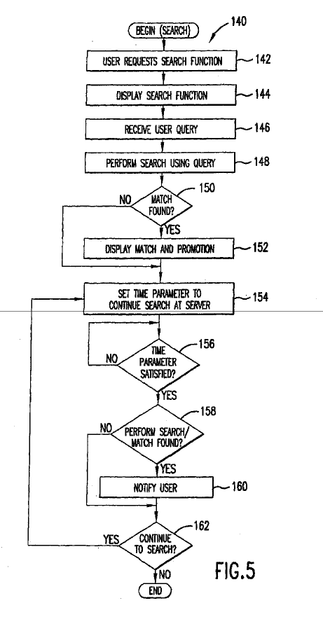

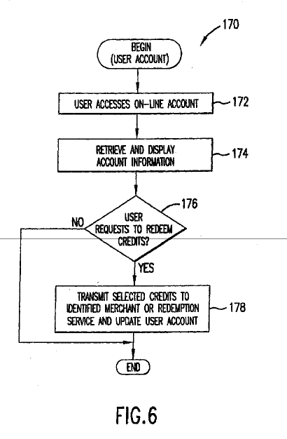

FIG. 6 is a flow chart of a method 170 for providing users access to on-line accounts. Method 170 can be implemented, for example, in software modules as part of agent application 24. In method 170, the user requests to access an on-line account (step 172). For example, section 184 for providing indication of promotions can also include an icon for the user to select to access an on-line account. Alternatively, the account can be accessed in other ways. Agent application 24 retrieves the user's account information from server 36 and displays it (step 174).

FIG. 12 is a diagram of a screen 218 for providing user account information. A section 220 can provide the user with credits available for redemption. For example, it can list for each transaction a description of the promotion 222, the date of viewing the promotion 224, and the number of credits awarded 226. Section 220 can optionally provide other information such as an indication of promotions viewed by or presented to the user. It can also include the user with an option to redeem credits 228. If the user requests to redeem a particular number of credits (step 176), agent application 24 transmits, for example, an indication of the identified credits to a selected merchant and updates the user's account (step 178). The credits can alternatively be redeemed in other ways.

The redemption need not be provided by the system server and rather, as an alternative, can be provided by another entity offering services for managing and redeeming credits. In this case, the software agent or system server can transmit to the redemption service the number of credits to issue to users and, when the user wants to redeem credits, the user can log onto a site for the redemption service or be transferred to the site. The user can be provided with other options for redemption such as calling in to the redemption service. The redemption service can permit conversion of the credits to, for example, airline miles for frequent flier programs, specific merchandise, or discounts with retailers. The redemption service, or the system server if providing that service, can communicate with the participating merchants or other entities in order to provide the conversion.

While the present invention has been described in connection with an exemplary embodiment, it will be understood that many modifications will be readily apparent to those skilled in the art, and this application is intended to cover any adaptations or variations thereof. For example, various types of user machines, notification messages, promotional information, and coupon information may be used without departing from the scope of the invention. This invention should be limited only by the claims and equivalents thereof.

What is claimed is:

1. A method for use in presenting on-line promotions to users, comprising:
monitoring a user's network interaction;
determining whether to present an available promotion to the user based upon user profile data and criteria related to the user's network interaction;
selectively presenting the available promotion to the user based upon the determining;
recording an indication of the presentation of the promotion to the user; and
confirming the occurrence of an off-line transaction related to the promotion by accessing transaction data obtained for the user in connection with a payment made over a third-party payment network.

2. The method of claim 1, wherein at least one of the monitoring and determining is performed locally, without transmitting a record of the user's network interaction over the network.

3. The method of claim 1, further including:
presenting an indication of the available promotion to the user; and
wherein selectively presenting the available promotion to the user is further based upon the user's response to the presenting of the indication of the promotion.

4. The method of claim 3, further including:
providing the user with a plurality of options for interacting with at least one of the indication of the promotion and the presented promotion; and
detecting a selection of one of the plurality of options by the user.

5. The method of claim 4, further including awarding redeemable credits to the user based upon selection of at least one of the plurality of options, the plurality of options including at least one of viewing the promotion; declining to view the promotion, deferring viewing the promotion, viewing and saving the promotion for later viewing, viewing additional promotions, viewing additional promotion information, visiting a vendor web site, completing a transaction, and spending at least a threshold dollar amount.

6. The method of claim 3, wherein the step of presenting an indication includes displaying an icon indicating an availability of the promotion, the method further including detecting a selection of the icon and presenting information concerning the promotion based upon the detecting.

7. The method of claim 6 further including transferring a user's network connection to a particular on-line site upon detecting at least one of selection of the icon and selection of the information concerning the promotion.

8. The method of claim 1, wherein the monitoring step includes detecting at least one of a network address of a web site accessed by the user, the presence of a term within the content of a web page accessed by the user and a search term entered by the user.

9. The method of claim 8, wherein the determining step includes comparing at least one of the network addresses for the accessed web sites with stored network addresses associated with the promotion, the content of accessed web sites with stored terms associated with the promotion, and the entered search terms with stored terms associated with the promotion.

10. The method of claim 9, further including repeatedly comparing a saved search term with updated stored terms, and transmitting a message to the user concerning the available promotion.

11. The method of claim 1, further including recording data related to the promotions presented to the user in the user's profile.

12. A method for use in presenting on-line promotions to a user, comprising:
storing a plurality of network addresses and key words associated with available promotions based upon user related criteria;
monitoring the user's network interaction;
locally determining whether the user's network interaction satisfies any of the stored plurality of network addresses and key words;
downloading, based upon the determining, a promotion associated with one of the plurality of network addresses and key words satisfied by the user's network interaction;
presenting, based upon the determining, an indication of the downloaded promotion to the user;
presenting the promotion to the user based upon the user's election to view the promotion; and
confirming the occurrence of an in-store transaction related to the presented promotion by accessing transaction data logged for the user in connection with a payment made over a third-party payment network.

13. A method of confirming a transaction related to an on-line promotion, the method comprising:
providing on-line a promotion to a user;
confirming an occurrence of an off-line transaction related to the on-line promotion by accessing transaction data obtained for the user in connection with a payment made over a third-party payment network.

14. The method of claim 13, further including determining from the accessed transaction data if the user has made a purchase from a particular vendor using at least one of a credit card, debit card, charge card, gift card and cellular phone.

15. The method of claim 13, wherein the providing step comprises providing the on-line promotion to the user based upon information stored in a user profile and at least one of a search term entered by the user, a web site accessed by the user, and content of a web site accessed by the user.

16. The method of claim 15, wherein the providing step further comprises providing the on-line promotion to the user based upon at least one of a date of access, time of access, repeated accessing of a site by the user, and geographic location of the user.

17. The method of claim 15, further comprising providing options enabling the user to elect when to view the on-line promotion.

18. The method of claim 15, wherein the providing step comprises providing the on-line promotion to the user via at least one of an email message, banner ad, pop-up window, instant message, electronic page, affiliated marketing link, SMS message and a text message.

19. The method of claim 15, wherein the step of confirming comprises recording an indication of a marketing link selected by the user on a web site.

20. The method of claim 15, further including presenting the user an option to at least one of view customer reviews related to the promotion, access a discussion forum related to the promotion, and access a chat feature related to the promotion.

21. The method of claim 13, wherein the providing step comprises providing the on-line promotion upon user login based upon user profile information associated with a user account.

22. The method of claim 21 further comprising providing at least one of additional promotions and additional promotion information based on at least one of entrance of a search term by the user and user interaction with content of a website.
